(19) United States
(12) Patent Application Publication
(10) Pub. No.: US 2026/0179552 A1
(43) Pub. Date: Jun. 25, 2026

(54) Display Device

(71) Applicant: LG Display Co., Ltd., Seoul (KR)

(72) Inventors: Dae Seok Oh, Paju-si (KR); Yong Hwa Park, Paju-si (KR); Seung Hwan Shin, Paju-si (KR)

(21) Appl. No.: 19/402,355

(22) Filed: Nov. 26, 2025

(30) Foreign Application Priority Data
Dec. 23, 2024 (KR) 10-2024-0193966

(51) Int. Cl. G09G 3/3233; G09G 3/20

(52) U.S. Cl. CPC G09G 3/3233; G09G 3/2092; G09G 2300/0819; G09G 2300/0842; G09G 2300/0861; G09G 2310/08; G09G 2320/0219; G09G 2320/0252; G09G 2330/021

(57) ABSTRACT

Embodiments of the present disclosure are directed to a display device that includes: a display panel including a plurality of pixels, each pixel having a light emitting element and a driving element; a data driver configured to input a data voltage to the plurality of pixels; a power supply module configured to input a reset voltage to an anode electrode of the light emitting element; a sensing module configured to sense a current flowing through the anode electrode of the light emitting element; a timing controller configured to control the data driver, the power supply module, and the sensing module; and a control switch module configured to selectively connect a reset power line for inputting the reset voltage to the power supply module or the sensing module.

### CROSS-REFERENCE TO RELATED APPLICATION

The present application claims priority to Republic of Korea Patent Application No. 10-2024-0193966, filed December 23, 2024, which is incorporated herein by reference in its entirety.

### BACKGROUND

### FIELD

Embodiments of the present disclosure relate to a display device.

### DISCUSSION OF RELATED ART

An organic light emitting display device includes a self-emissive organic light emitting diode (hereinafter, "OLED") and has advantages of a fast response speed, high luminous efficiency, high luminance, and a wide viewing angle. The organic light emitting display device not only provides a fast response speed and excellent luminous efficiency, luminance, and viewing angle, but also can express a black grayscale level as a complete black, thereby achieving an excellent contrast ratio and color reproduction rate.

The display device includes a display panel on which a plurality of pixels are formed, a gate driver for supplying a scan signal to the display panel, and a source driver for supplying a data signal to the display panel. A plurality of pixel lines are provided in the display panel, and each pixel line is composed of a plurality of pixels. While a gate signal is applied to one pixel line, the pixels of the pixel line are simultaneously charged with the data signal.

A gate signal applied in a horizontal direction is delayed due to an internal load of the display panel, and the amount of delay of the gate signal increases as the distance from the gate driver increases.

Accordingly, in a large-sized display device, a gate circuit is added within the display area to mitigate this delay. However, when the gate circuit is arranged in the display area, parasitic capacitance is generated in unintended regions, which causes abnormal sampling during a sampling period for internal compensation, resulting in a dim line due to a decrease in luminance and thus deteriorating image quality.

### SUMMARY

Embodiments of the present disclosure are directed to a display device having excellent image quality in which dim lines are eliminated.

The objectives of the present disclosure are not limited to those described above, and other objectives not mentioned will be clearly understood by those skilled in the art from the following description.

A display device according to one or more embodiments of the present disclosure includes: a display panel including a plurality of pixels, each having a light emitting element and a driving element; a data driver configured to input a data voltage to the plurality of pixels; a power supply module configured to input a reset voltage to an anode electrode of the light emitting element; a sensing module configured to sense a current flowing through the anode electrode of the light emitting element; a timing controller configured to control the data driver, the power supply module, and the sensing module; and a control switch module configured to selectively connect a reset power line for inputting the reset voltage to the power supply module or the sensing module.

The timing controller may control the control switch module to connect the reset power line to the power supply module when sensing a threshold voltage of the driving element, and to connect the reset power line to the sensing module when the sensing module operates.

The sensing module may convert a sensed current into a digital signal and transmit the digital signal to the timing controller, and the timing controller may generate compensation data using the digital signal and transmit image data, to which the compensation data is applied, to the data driver.

Each of the plurality of pixels may include an internal compensation circuit configured to sense a threshold voltage of the driving element.

The driving element may include a gate electrode connected to a first node, a first electrode connected to a second node, and a second electrode connected to a third node, and the display device may further include: a first switch element connected between the second node and a data line and configured to be turned on in response to a second scan signal; a second switch element connected between the second node and a stress voltage and configured to be turned on in response to a third scan signal; and a third switch element connected between the anode electrode of the light emitting element and the reset voltage and configured to be turned on in response to the third scan signal.

The display device may further include: a fourth switch element connected between the first node and an initialization voltage and configured to be turned on in response to a fourth scan signal; a fifth switch element connected between the first node and the third node and configured to be turned on in response to a first scan signal; a sixth switch element connected between the second node and a pixel driving voltage and configured to be turned on in response to an emission control signal; and a seventh switch element connected between the third node and the anode electrode and configured to be turned on in response to the emission control signal.

When the display panel is in an off state, the sensing module may sense a current flowing through the anode electrode of the light emitting element by connecting the sensing module to the reset power line while a voltage is applied to the light emitting element.

The plurality of pixels may constitute a first light emitting line and a second light emitting line, and the control switch module may include: a first control switch connected to a first reset power line that is connected in common to the plurality of pixels of the first light emitting line; and a second control switch connected to a second reset power line that is connected in common to the plurality of pixels of the second light emitting line.

The first light emitting line may be a line that does not satisfy a predetermined luminance range, and the second light emitting line may be a line that satisfies the predetermined luminance range, and the timing controller may include a memory in which position information of the first light emitting line and position information of the second light emitting line are stored.

The timing controller may sense the display panel on a block-by-block basis, and, for each block, the timing controller may apply a voltage to the first light emitting line to sense a first current value of the light emitting elements, apply a voltage to the second light emitting line to sense a second current value of the light emitting elements, and compare the first current value and the second current value to calculate compensation data.

A display device according to one or more embodiments of the present disclosure includes: a display panel including a plurality of pixels, each having a light emitting element and a driving element; a data driver configured to apply a data signal to the plurality of pixels; a gate driver configured to apply a scan signal to the plurality of pixels; a power supply module configured to input a reset voltage through a reset power line connected to an anode electrode of the light emitting element; a sensing module configured to sense a current flowing through the light emitting element by applying a voltage to a first light emitting line and a second light emitting line in which the plurality of pixels are connected; and a timing controller configured to generate compensation data by comparing a first current value sensed from the first light emitting line with a second current value sensed from the second light emitting line, wherein the sensing module applies a voltage to the first light emitting line to sense the first current value flowing through the light emitting elements via a first reset power line connected to the first light emitting line, and applies a voltage to the second light emitting line to sense the second current value flowing through the light emitting elements via a second reset power line connected to the second light emitting line.

The first light emitting line may be a line that does not satisfy a predetermined luminance range, and the second light emitting line may be a line that satisfies the predetermined luminance range, and the display device may further include a memory in which position information of the first light emitting line and position information of the second light emitting line are stored.

The display device may further include a control switch module including a first control switch connected to a first reset power line that is connected in common to the plurality of pixels of the first light emitting line, and a second control switch connected to a second reset power line that is connected in common to the plurality of pixels of the second light emitting line, wherein the control switch module may selectively connect the reset power lines to the power supply module or the sensing module.

The timing controller may control the control switch module to connect the reset power line to the power supply module when sensing a threshold voltage of the driving element, and to connect the reset power line to the sensing module when the sensing module operates in a sensing mode.

The timing controller may sense the display panel on a block-by-block basis, and, for each block, the timing controller may apply a voltage to the first light emitting line to sense the first current value of the light emitting elements, apply a voltage to the second light emitting line to sense the second current value of the light emitting elements, and compare the first current value and the second current value to calculate the compensation data.

According to one or more embodiments, dim lines may be eliminated, thereby preventing luminance defects. The lifetime of the display device may thus be improved.

The effects of the present disclosure are not limited to those mentioned above, and other effects not mentioned will be clearly understood by those skilled in the art from the description of the claims.

### BRIEF DESCRIPTION OF THE DRAWINGS

The above and other objects, features, and advantages of the present disclosure will become more apparent to those of ordinary skill in the art by describing embodiments thereof in detail with reference to the attached drawings, in which:

FIG. 1 is a block diagram of a display device according to one or more embodiments of the present disclosure.

FIG. 2 is a schematic diagram of a display device according to one or more embodiments of the present disclosure.

FIG. 3 is a diagram illustrating a structure in which a plurality of pixels are connected to a power supply module and a sensing module according to one or more embodiments of the present disclosure.

FIG. 4 is a diagram illustrating a first light emitting line according to one or more embodiments of the present disclosure.

FIG. 5 is a diagram illustrating a second light emitting line according to one or more embodiments of the present disclosure.

FIG. 6 is a block diagram of a timing controller according to one or more embodiments of the present disclosure.

FIG. 7 is a diagram illustrating compensation data according to one or more embodiments of the present disclosure.

FIG. 8 is a schematic diagram of a display device in which a reset power line is connected in common according to one or more embodiments of the present disclosure.

FIG. 9 is a diagram illustrating a process in which a display panel is sensed block by block according to one or more embodiments of the present disclosure.

FIG. 10 is a diagram of a data driver and a sensing module according to one or more embodiments of the present disclosure.

FIG. 11 is a diagram illustrating a driving sequence of a sensing mode according to one or more embodiments of the present disclosure.

FIG. 12 is a circuit diagram of a pixel circuit according to one or more embodiments of the present disclosure.

FIG. 13 is a waveform diagram illustrating a normal mode of the pixel circuit according to one or more embodiments of the present disclosure.

FIG. 14A is a circuit diagram illustrating an operation of the pixel circuit during a first on-bias period according to one or more embodiments of the present disclosure.

FIG. 14B is a circuit diagram illustrating an operation of the pixel circuit during an initialization period according to one or more embodiments of the present disclosure.

FIG. 14C is a circuit diagram illustrating an operation of the pixel circuit during a sampling period according to one or more embodiments of the present disclosure.

FIG. 14D is a circuit diagram illustrating an operation of the pixel circuit during a second on-bias period according to one or more embodiments of the present disclosure.

FIG. 14E is a circuit diagram illustrating an operation of the pixel circuit during an emission period according to one or more embodiments of the present disclosure.

FIG. 15 is a waveform diagram illustrating a sensing mode of the pixel circuit according to one or more embodiments of the present disclosure.

FIG. 16 is a circuit diagram illustrating an operation of the pixel circuit during a current sensing period according to one or more embodiments of the present disclosure.

FIG. 17 is a circuit diagram illustrating an operation of the pixel circuit during an off period according to one or more embodiments of the present disclosure.

### DETAILED DESCRIPTION

The advantages and features of the present disclosure, and methods of achieving them will be apparent from the embodiments described in detail below in conjunction with the accompanying drawings. The present disclosure is not limited to the following embodiments, which may be implemented in various different forms; rather, the present embodiments are provided to make the disclosure of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of describing the embodiments of the present disclosure are merely examples, and the present disclosure is not limited thereto. Like reference numerals generally denote like elements throughout the present disclosure. Further, in describing the present disclosure, detailed descriptions of known related technologies may be omitted so as not to unnecessarily obscure the subject matter of the present disclosure.

The terms such as "comprising," "including," "having," and "consisting of" used herein are generally intended to allow other components to be added unless the terms are used with the term "only." References to the singular shall be construed to include the plural unless expressly stated otherwise.

In the interpretation of components, they are construed to include margins of error, even if not explicitly stated.

When describing a positional or interconnected relationship between two components, such as "on top of," "above," "below," "next to," "connect or couple with," "crossing," "intersecting," etc., one or more other components may be interposed between them unless "immediately" or "directly" is used.

When describing a temporal contextual relationship is described, such as "after," "following," "next to," or "before," it may not be continuous on a time scale unless "immediately" or "directly" is used.

The first, second, and so on may be used to distinguish the components, but the functions or structures of these components are not limited to the ordinal number or component name attached to the component.

The following embodiments may be combined or associated with each other in whole or in part, and various types of interlocking and driving are technically possible. The embodiments may be implemented independently of one another or may be implemented together in an interrelated relationship.

In the display device of the present disclosure, the pixel circuit and the gate driver may include a plurality of transistors. The transistors may be implemented as an oxide thin film transistor (TFT) including an oxide semiconductor or a low temperature poly silicon TFT (LTPS TFT) including a low temperature poly silicon (LTPS).

A transistor is a three-electrode element including a gate, a source, and a drain. The source is an electrode that supplies carriers to the transistor. In the transistor, the carriers start to flow from the source. The drain is an electrode through which the carriers exit in the transistor. In the transistor, the carriers flow from the source to the drain. In the case of an n-channel transistor, since the carriers are electrons, a source voltage is lower than a drain voltage, allowing the electrons to flow from the source to the drain. In the n-channel transistor, the direction of current is from the drain to the source. In the case of a p-channel transistor, since the carriers are holes, a source voltage is higher than a drain voltage such that the holes can flow from the source to the drain. In the p-channel transistor, the current flows from the source to the drain because the holes flow from the source to the drain. It should be noted that the source and the drain of the transistor are not fixed. For example, the source and the drain may be changed according to an applied voltage. Therefore, the present disclosure is not limited by the source and the drain of the transistor.

A gate signal may swing between a gate-on voltage and a gate-off voltage. The transistor is turned on in response to the gate-on voltage and is turned off in response to the gate-off voltage. In the case of the n-channel transistor, the gate-on voltage may be a gate high voltage VGH, and the gate-off voltage may be a gate low voltage VGL. In case of the p-channel transistor, the gate-on voltage may be a gate low voltage VGL, and the gate-off voltage may be a gate high voltage VGH.

Hereinafter, various embodiments of the present disclosure will be described in detail with reference to the accompanying drawings

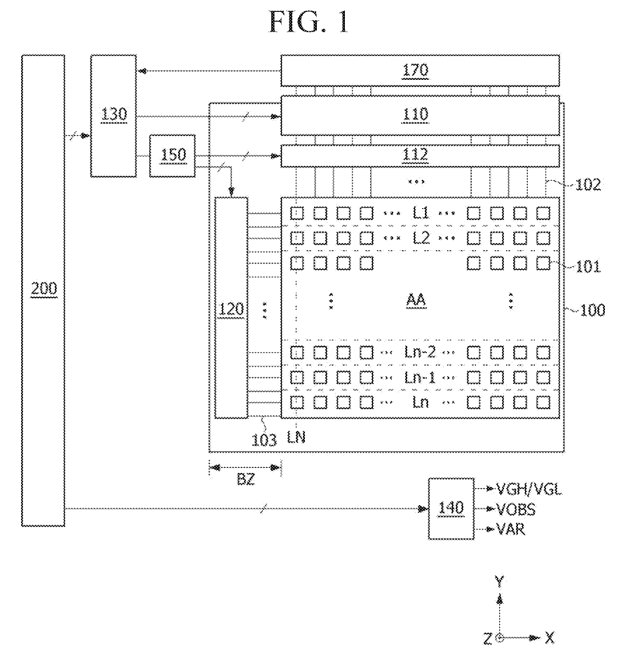

FIG. 1 is a block diagram of a display device according to one or more embodiments of the present disclosure.

Referring to FIG. 1, a display device according to one or more embodiments of the present disclosure includes a display panel 100, a display panel driving circuit for writing pixel data to the pixels of the display panel 100, a power supply module 140 for generating power required to drive the pixels and the display panel driving circuit, and a sensing module 170 for sensing a current of a light emitting element located on a light emitting line.

The display panel 100 may be manufactured from a plastic substrate, a thin glass substrate, a metal substrate, or the like. Pixels 101 are implemented on the display panel 100.

The display panel 100 may be a panel with a rectangular structure having a length in an X-axis direction, a width in a Y-axis direction, and a thickness in a Z-axis direction, but is not limited thereto. A display area AA of the display panel 100 includes a pixel array for displaying an input image. The pixel array includes a plurality of data lines 102, a plurality of gate lines 103 intersecting the data lines 102, and the pixels 101 arranged in a matrix form. The display panel 100 may further include power lines connected in common to the pixels 101. The power lines are connected to constant voltage nodes of the pixel circuits and supply a constant voltage required for driving the pixels 101 to the pixels 101.

Each of the pixels 101 may be divided into a red sub-pixel, a green sub-pixel, and a blue sub-pixel for color implementation. Each of the pixels may further include a white sub-pixel. Each of the sub-pixels includes a pixel circuit for driving a light emitting element. Each pixel circuit is connected to a data line, gate lines, and power lines. Hereinafter, a "pixel" may be interpreted as a "sub-pixel".

The pixels may be arranged as real color pixels or PenTile pixels. The PenTile pixel may implement a higher resolution than the real color pixel by driving two sub-pixels with different colors as one pixel 101 using a preset pixel rendering algorithm. The pixel rendering algorithm may compensate for the insufficient color representation in each pixel with the color of light emitted from an adjacent pixel.

The pixel array includes a plurality of pixel lines L1 to Ln. Each of the pixel lines L1 to Ln includes one line of pixels arranged along the line direction (the X-axis direction) in the pixel array of the display panel 100. The pixels arranged in one pixel line share the gate lines 103. The sub-pixels arranged in the column direction (the Y-axis direction) along a data line direction share the same data line 102. One horizontal period is a time obtained by dividing one frame period by the total number of the pixel lines L1 to Ln.

The display panel 100 may be implemented as a non-transmissive display panel or a transmissive display panel. The transmissive display panel may be applied to a transparent display device in which an image is displayed on the screen while a real object in the background is visible. The display panel 100 may be manufactured as a flexible display panel.

The power supply module 140 generates a constant voltage (or a direct current (DC) voltage) required for driving the pixel array of the display panel 100 and the display panel driving circuit by using a DC-DC converter. The DC-DC converter may include a charge pump, a regulator, a buck converter, a boost converter, and the like. The power supply module 140 may adjust the level of a DC input voltage applied from a host system 200 to output constant voltages such as a reset voltage, a gamma reference voltage, a gate high voltage, a gate low voltage, a pixel driving voltage, a cathode voltage, and an initialization voltage. The gamma reference voltage is supplied to a data driver 110. The dynamic range of a data voltage outputted from the data driver 110 is determined according to the voltage range of the gamma reference voltage. The dynamic range of the data voltage is a voltage range between a highest grayscale voltage and a lowest grayscale voltage.

The gate high voltage and the gate low voltage are supplied to a level shifter 150 and a gate driver 120. The constant voltages such as a pixel driving voltage, a cathode voltage, and an initialization voltage are supplied to the pixels 101 through the power lines connected in common to the pixels 101.

The display panel driving circuit writes pixel data of an input image to the pixels 101 of the display panel 100 under the control of a timing controller 130. The display panel driving circuit includes the data driver 110 and the gate driver 120. The display panel driving circuit may further include a demultiplexer array 112 located between the data driver 110 and the data lines 102.

The demultiplexer array 112 sequentially supplies data voltages outputted from the channels of the data driver 110 to the data lines 102 using a plurality of demultiplexers (DEMUX). The demultiplexer may include a plurality of switch elements arranged on the display panel 100. When the demultiplexer is arranged between the output terminals of the data driver 110 and the data lines 102, the number of channels of the data driver 110 may be reduced. The demultiplexer array 112 may be omitted.

The display panel driving circuit may further include a touch sensor driver for driving touch sensors. The touch sensor driver is omitted in FIG. 1. The data driver 110 and the touch sensor driver may be integrated into a single driver integrated circuit (IC). The timing controller 130, the power supply module 140, the level shifter 150, the data driver 110, the touch sensor driver, and the like may be integrated into a single driver IC.

The data driver 110 receives the pixel data of the input image as a digital signal from the timing controller 130 and outputs a data voltage. The data driver 110 uses a digital to analog converter (DAC) to convert the pixel data of the input image into a gamma compensation voltage, thereby outputting the data voltage. The gamma reference voltage (VGMA) is divided into gamma compensation voltages for each grayscale level through a voltage divider circuit of the data driver 110 and is provided to the DAC. The DAC generates the data voltage as a gamma compensation voltage corresponding to a grayscale value of the pixel data. The data voltage outputted from the DAC may be outputted to the data line 102 through an output buffer in each channel of the data driver 110, or may be outputted to the data line 102 via the demultiplexer array 112.

The gate driver 120 may include a plurality of shift registers for sequentially shifting pulses of gate signals. The gate driver 120 may sequentially supply the gate signals to the gate lines 103 by shifting the pulses of the gate signals using the shift registers. The gate driver 120 may output a plurality of gate signals having different phases and pulse widths by using the plurality of shift registers. The gate signals may be divided into a scan signal and an emission control signal (hereinafter referred to as an "EM signal").

The gate driver 120 may be located in one of a left non-display area BZ and a right non-display area BZ, which are outside the display area AA in the display panel 100, and may supply the gate signals to the gate lines 103 in a single feeding manner. In the single feeding, the gate signals are applied to one end of the gate line 103. The gate driver 120 may be located in both the left and right non-display areas BZ of the display panel 100 and may apply the gate signals to the gate lines 103 in a double feeding manner. In the double feeding manner, the gate signals are simultaneously applied to both ends of the gate line 103. At least a part of the circuit of the gate driver 120 may be located in the display area AA.

A part of the gate driver 120 may be located in the non-display area BZ outside the display area AA in the display panel 100, and another part may be located in the display area AA, thereby reducing the delay in the gate lines. However, since a part of the gate driver 120 is located in the display area AA, there is a problem in that parasitic capacitance is generated in an unintended position in the display area AA, causing inaccurate sampling for internal compensation. Accordingly, a dim line that appears relatively dark or bright may occur when the panel is driven.

The timing controller 130 receives digital video data of the input image and timing signals synchronized with the data from the host system 200. The timing signals may include a vertical synchronization signal (Vsync), a horizontal synchronization signal (Hsync), a data enable signal (DE), and the like. Since a vertical period and a horizontal period can be known by counting the data enable signal (DE), the vertical synchronization signal (Vsync) and the horizontal synchronization signal (Hsync) may be omitted. The data enable signal (DE) has a period corresponding to one horizontal period (1H).

Based on the timing signals (Vsync, Hsync, and DE) received from the host system 200, the timing controller 130 generates a data timing control signal for controlling the operation timing of the data driver 110, a MUX control signal for controlling the operation timing of the demultiplexer array 112, and a gate timing control signal for controlling the operation timing of the gate driver 120. The timing controller 130 controls the operation timing of the display panel driving circuit to synchronize the data driver 110, the demultiplexer array 112, the touch sensor driver, and the gate driver 120.

The gate timing control signal generated from the timing controller 130 may be inputted to the shift registers of the gate driver 120 through the level shifter 150. The level shifter 150 may receive the gate timing control signal to generate a start pulse and a shift clock, and provide them to the gate driver 120 through clock lines. The level shifter 150 may supply the MUX control signal to the demultiplexer array 112. An input signal of the level shifter 150 is a signal having a digital signal voltage level, and an output signal of the level shifter 150 may be an analog voltage signal that swings between a gate high voltage (VGH) and a gate low voltage (VGL).

The sensing module 170 may sense a current applied to the light emitting elements of the plurality of pixels 101. The sensing module 170 may sense the current of the light emitting elements for each of a plurality of light emitting lines LN. The light emitting line LN may be in a second direction (the Y-axis direction) perpendicular to a horizontal line, but may also be in a first direction parallel to the horizontal line.

The timing controller 130 may generate compensation data of the light emitting line by comparing current values of the light emitting elements for each light emitting line from the sensing module 170. Thereafter, when transmitting image data to drive the pixels of the corresponding light emitting line, the timing controller 130 may transmit image data reflecting the compensation data.

The host system 200 may include a main board of any one of a television (TV) system, a set-top box, a navigation system, a personal computer (PC), a vehicle system, a mobile terminal, and a wearable terminal. The host system may scale an image signal from a video source to fit the resolution of the display panel 100 and transmit the scaled image signal together with the timing signals to the timing controller 130.

The host system 200 may be implemented as an application processor (AP). The host system 200 may transmit the pixel data of the input image to the data driver 110 through a mobile industry processor interface (MIPI).

Each of the sub-pixels includes a pixel circuit having a driving element for driving a light emitting element and a capacitor connected to the driving element. The pixel circuit of each of the sub-pixels may include an internal compensation circuit to compensate the data voltage by the threshold voltage of the driving element.

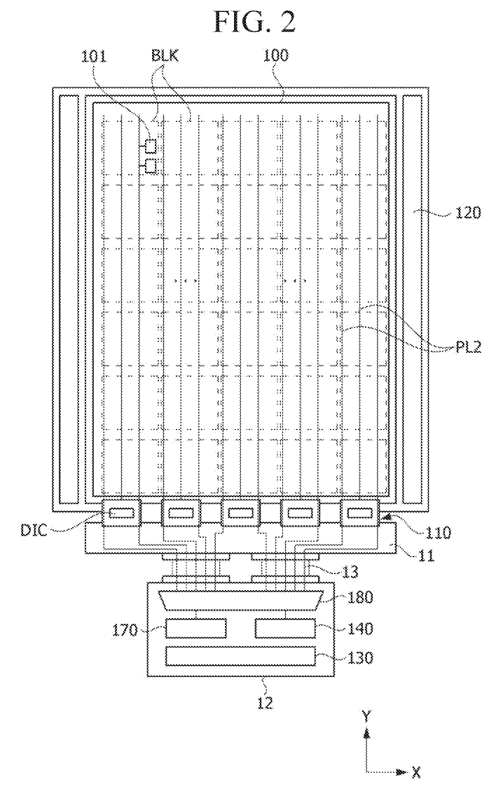

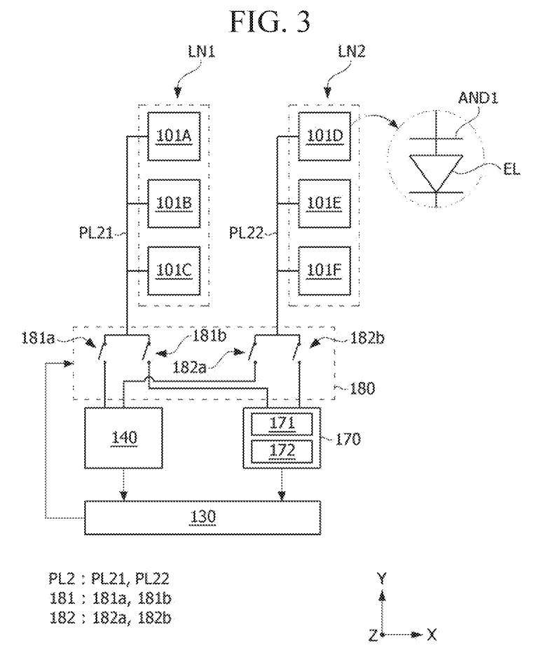

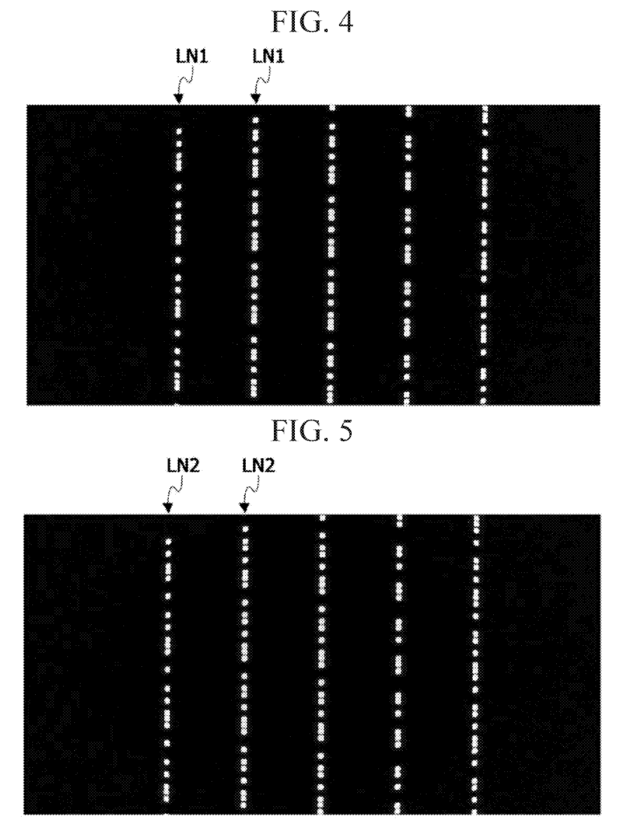

FIG. 2 is a schematic diagram of a display device according to one or more embodiments of the present disclosure. FIG. 3 is a diagram illustrating a structure in which a plurality of pixels are connected to a power supply module and a sensing module according to one or more embodiments of the present disclosure. FIG. 4 is a diagram illustrating a first light emitting line according to one or more embodiments of the present disclosure. FIG. 5 is a diagram illustrating a second light emitting line according to one or more embodiments of the present disclosure.

Referring to FIG. 2, the data driver 110 may be implemented in a chip on film (COF) manner. In this case, a plurality of data driving chips DIC functioning as the data driver 110 are mounted on a flexible film, and one end of the flexible film may be bonded to a source printed circuit board 11, and the other end may be bonded to the display panel 100. However, the present embodiments are not limited thereto. For example, the data driver 110 may be connected to a bonding pad of the display panel 100 in a tape automated bonding (TAB) manner or a chip on glass (COG) manner.

The source printed circuit board 11 may be positioned around the display panel 100 and may be connected to a control printed circuit board 12 through a flexible flat cable (FFC) 13. The source printed circuit board 11 may receive voltages and signals for driving the display panel 100 from the control printed circuit board 12 and process them.

The timing controller 130 is located on the control printed circuit board 12. The power supply module 140 may be further located on the control printed circuit board 12.

According to one or more embodiments, the data driver 110 may include the plurality of data driving chips DIC arranged in the first direction (the X-axis direction) on one side of the display panel. A plurality of reset power lines PL2 may extend in the second direction on the display panel. The plurality of reset power lines PL2 may be spaced apart from each other in the first direction. A plurality of reset power lines PL2 may form a group to be connected to each data driving chip DIC. The same number of reset power lines PL2 may be connected to each data driving chip DIC. According to one or more embodiments, the reset power lines PL2 may be separated according to the number of the data driving chips DIC.

The plurality of reset power lines PL2 may be connected to a control switch module 180 located on the control printed circuit board 12. The control switch module 180 may selectively connect the plurality of reset power lines PL2 to the power supply module 140 or the sensing module 170. The control switch module 180 may include a plurality of control switches for switching each of the plurality of reset power lines PL2 to the power supply module 140 or the sensing module 170.

Referring to FIG. 3, a plurality of pixels 101 may be arranged in the second direction to form a plurality of light emitting lines LN1 and LN2. The plurality of light emitting lines LN1 and LN2 may be located spaced apart from each other in the first direction. For example, first to third pixels 101A, 101B, and 101C arranged in the second direction may form a first light emitting line LN1, and fourth to sixth pixels 101D, 101E, and 101F may form a second light emitting line LN2. Each pixel 101 may refer to a sub-pixel.

The reset power line PL2 may be connected in common to the pixels 101 located in each light emitting line. A first reset power line PL21 connected to the plurality of pixels 101 of the first light emitting line LN1 may be selectively connected to the power supply module 140 or the sensing module 170 by a first control switch 181. The first control switch 181 may include a first-first control switch 181a that connects the first reset power line PL21 to the power supply module 140, and a first-second control switch 181b that connects the first reset power line PL21 to the sensing module 170.

A second reset power line PL22 connected to the plurality of pixels 101 of the second light emitting line LN2 may be selectively connected to the power supply module 140 or the sensing module 170 by a second control switch 182. The second control switch 182 may include a second-first control switch 182a that connects the second reset power line PL22 to the power supply module 140, and a second-second control switch 182b that connects the second reset power line PL22 to the sensing module 170.

The sensing module 170 may include an amplifying module 171 that amplifies a received current level, and an analog-to-digital conversion module 172 that converts the amplified signal into a digital signal.

During threshold voltage compensation of the driving element, the reset power line PL2 may be connected to the power supply module 140 and may apply a reset voltage to an anode electrode AND1 of a light emitting element EL, thereby preventing the light emitting element EL from being turned on during sampling. When sensing a current of the light emitting element EL, the reset power line PL2 may be connected to the sensing module 170 and may sense a current flowing through the anode electrode AND1 of the turned-on light emitting element EL (or a current flowing through the light emitting element EL). According to one or more embodiments, since the current flowing through the anode electrode AND1 of the light emitting element EL is sensed using the reset power line PL2 to generate compensation data, there is an advantage in that a difference in luminance can be accurately sensed and accurate compensation data can be calculated.

Referring to FIG. 4, the first light emitting line LN1 may be a dim-line having a relatively low or high luminance compared to the second light emitting line LN2. The first light emitting line LN1 may be a line that does not satisfy a predetermined luminance range. Referring to FIG. 5, the second light emitting line LN2 may be a line that satisfies the predetermined luminance range. The second light emitting line LN2 may be a target line having a target luminance. Position information for the first light emitting line LN1 and the second light emitting line LN2 may be acquired in advance through a pre-shipment luminance inspection or the like, and the acquired position information may be stored in advance in a memory 190.

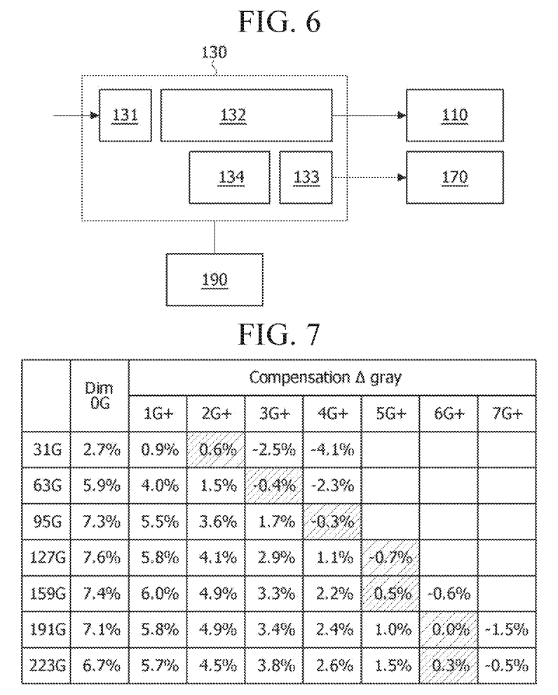

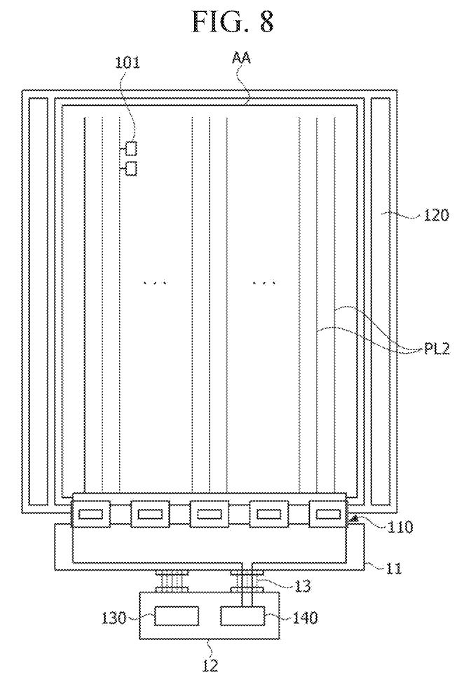

FIG. 6 is a block diagram of a timing controller according to one or more embodiments of the present disclosure. FIG. 7 is a diagram showing compensation data according to one or more embodiments of the present disclosure. FIG. 8 is a schematic diagram of a display device in which a reset power line is connected in common according to one or more embodiments of the present disclosure.

Referring to FIG. 3 and FIG. 6, the timing controller 130 may receive current values of the plurality of first light emitting lines LN1 and current values of the plurality of second light emitting lines LN2 from the sensing module 170. The timing controller 130 may compare the current values of the first light emitting line LN1 with the current values of the second light emitting line LN2 to generate compensation data.

The timing controller 130 may include a receiving module 133 that receives data from the sensing module 170, a compensation data generating module 134 that compares the current values of the first light emitting line LN1 with the current values of the second light emitting line LN2 to generate compensation data, and a data transmitting module 132 that transmits image data to which the compensation data is applied. The compensation data generating module 134 may calculate a luminance deviation according to differences between the current values of the first light emitting line LN1 and the current values of the second light emitting line LN2, and generate the compensation data for each grayscale level.

The compensation data generating module 134 may generate the compensation data by comparing the current values of the first light emitting line LN1 and the second light emitting line LN2 for each grayscale level. For example, if the current value of the first light emitting line LN1, measured by applying a pattern signal of the 31st grayscale level, is determined to be lower than that of the second light emitting line LN2 by about two levels, the compensation data generating module 134 may generate the compensation data such that a gamma voltage two levels higher is selected when applying a data voltage corresponding to the 31st grayscale level to the corresponding light emitting line. For the method of generating the compensation data by comparing the current values, various known algorithms may be applied. For example, grayscale compensation information corresponding to a current difference for each grayscale level may be stored in advance in the memory 190.

An image data receiving module 131 may receive the image data from the host on a frame-by-frame basis and restore a clock and the image data. The data transmitting module 132 may transmit the image data corresponding to one horizontal period to the data driver 110. In this case, the data transmitting module 132 may transmit modulated image data, which is generated by applying the compensation data to the image data of each pixel 101. The modulated image data may be transmitted to the data driver 110.

Referring to FIG. 7, the compensation data may be stored in the form of a look-up table for each grayscale level. Dim 0G is a luminance difference between the first light emitting line LN1, which is a dim-line, and the second light emitting line LN2, which is a normal line. At the 31st grayscale level, the luminance difference between the first light emitting line LN1 and the second light emitting line LN2 is 2.7%, and thus a vertical line may be visually recognized. When the luminance difference is 1% or more, there is a problem in that a vertical line pattern is visible and thus the image quality is deteriorated.

According to one or more embodiments, when transmitting image data such that a data voltage corresponding to the 31st grayscale level is outputted to the first light emitting line LN1, the data transmitting module 132 may apply the compensation data from the look-up table to compensate and transmit the image data such that a data voltage of the 33rd grayscale level is outputted. In this case, the first light emitting line LN1 may have a luminance difference of about -0.6% with respect to the luminance of the second light emitting line LN2. When the luminance difference is 1% or less, it is not observed by the naked eye, and thus the luminance may be uniformly controlled.

For example, in the case of the 127th grayscale level, the luminance may be uniformly controlled by modulating the data such that a data voltage corresponding to the 132nd grayscale level, which is raised by 5 levels, is outputted to the first light emitting line LN1. For example, in the case of the 191st grayscale level, the luminance may be uniformly controlled by modulating the data such that a data voltage corresponding to the 197th grayscale level, which is raised by 6 levels, is outputted.

FIG. 8 is a schematic diagram of a display device in which a reset power line is connected in common according to one or more embodiments of the present disclosure.

Referring to FIG. 8, general reset power lines PL2 are all connected as a common line to the power supply module 140. In contrast, the reset power lines PL2 according to one or more embodiments may be connected to the data driving chips DIC on a group-by-group basis, and may be connected to the sensing module 170 through a respective switch module of a switch array. Therefore, the current value of the light emitting elements may be sensed for each line.

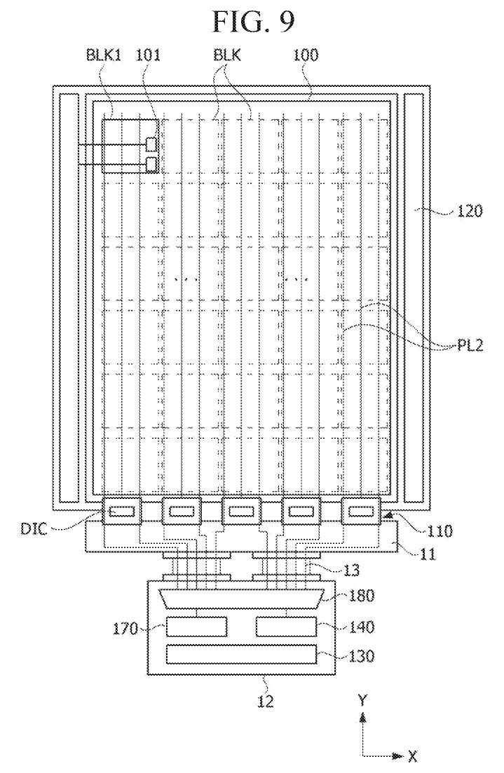

Referring to FIG. 9, the timing controller 130 may partition the display panel into a plurality of blocks BLK and sense the current values of the first light emitting line LN1 and the second light emitting line LN2 for each block BLK. A plurality of the first light emitting lines LN1 and the second light emitting lines LN2 may be arranged in each block BLK. The number of the first light emitting lines LN1 and the number of the second light emitting lines LN2 may be different for each block BLK. In some blocks BLK, the number of the second light emitting lines LN2 may be greater than the number of the first light emitting lines LN1, and in some other blocks BLK, the number of the first light emitting lines LN1 may be greater than the number of the second light emitting lines LN2.

The timing controller 130 may sense the current of the light emitting elements while sequentially causing the plurality of blocks BLK to emit light. For example, the timing controller 130 may connect the reset power line PL2 to the sensing module 170 while causing the first light emitting lines LN1 of the first block BLK to emit light. In this case, the timing controller 130 may control the gate driver 120 such that a signal is applied only to a gate line connected to the first block BLK. Therefore, among the pixels 101 arranged in the first block BLK, only the pixels 101 arranged on the first light emitting line LN1 emit light, and thus only the current values of the light emitting elements of the first light emitting line LN1 within the first block BLK may be sensed. In the same manner, only the current values of the light emitting elements of the second light emitting line LN2 within the first block BLK may be sensed.

The sensing module 170 may include a plurality of sensing blocks connected through each data driving chip DIC. For example, when five data driving chips DIC are arranged, the sensing module 170 may also have five sensing blocks. Each sensing block may sense a current value from the reset power line PL2 connected to a corresponding data driving chip DIC and transmit the sensed current value to the timing controller 130. Data of the current value sensed by each sensing block may be assigned a unique ID. Therefore, the timing controller 130 may check the ID of the received data to identify which sensing block transmitted the current value.

According to one or more embodiments, an advantage is provided in that the data can be compensated for more precisely since the compensation data is generated by sensing the current on a block-by-block basis. Although one or more embodiments in which the display panel is divided into 30 blocks have been exemplified, the present embodiments are not limited thereto.

Referring to FIG. 10, the sensing module 170 may be configured as a separate integrated circuit on the source printed circuit board 11 or the control printed circuit board 12, but is not limited thereto. For example, the control switch module 180 and the sensing module 170 may be configured as a single integrated circuit (DSIC) together with the data driver 110.

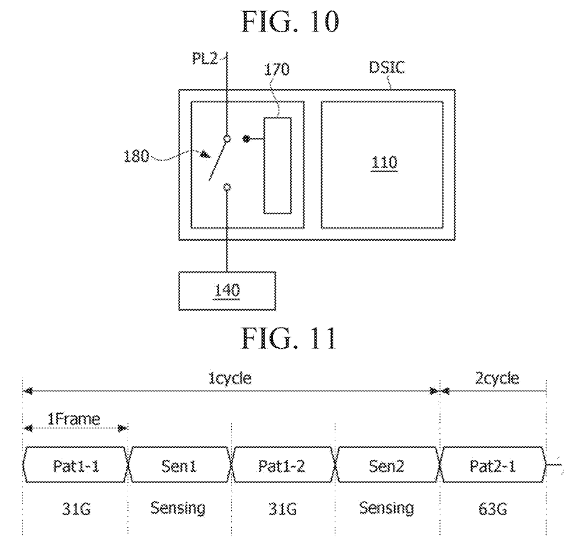

FIG. 11 is a diagram illustrating a driving sequence of a sensing mode according to one or more embodiments of the present disclosure.

Referring to FIG. 11, the step of sensing the current of the light emitting element may be performed by repeatedly executing a first emission period Pat1-1, a first sensing period Sen1, a second emission period Pat1-2, and a second sensing period Sen2 on a frame-by-frame basis.

In the first emission period Pat1-1, a pattern image may be outputted to the first light emitting line LN1 to cause the first light emitting line LN1 to emit light. In this case, the reset power line PL2 may be connected to the power supply module 140, and a reset voltage may be applied to the anode electrode of the light emitting element.

In the first sensing period Sen1, while the pattern image is maintained, the reset power line PL2 may be connected to the sensing module 170 to sense a current flowing through the anode electrode of the light emitting element via the reset power line PL2 and transmit the sensed current to the timing controller 130.

In the second emission period Pat1-2, a pattern image may be outputted to the second light emitting line LN2 to cause the second light emitting line LN2 to emit light. In this case, the reset power line PL2 may be connected to the power supply module 140, and a reset voltage may be applied to the anode electrode of the light emitting element.

In the second sensing period Sen2, while the pattern image is maintained, the reset power line PL2 may be connected to the sensing module 170 to sense a current flowing through the anode electrode of the light emitting element via the reset power line PL2 and transmit the sensed current to the timing controller 130.

The first emission period Pat1-1, the first sensing period Sen1, the second emission period Pat1-2, and the second sensing period Sen2 may be repeated for each grayscale level as one cycle. For example, in a first cycle, the current value of the first light emitting line LN1 and the current value of the second light emitting line LN2 may be sensed by inputting a pattern image of the 31st grayscale level to the first light emitting line LN1 and the second light emitting line LN2. In a second cycle, the current value of the first light emitting line LN1 and the current value of the second light emitting line LN2 may be sensed by inputting a pattern image of the 63rd grayscale level to the first light emitting line LN1 and the second light emitting line LN2. Therefore, since the current value of the first light emitting line LN1 and the current value of the second light emitting line LN2 may be sensed for each grayscale level, the timing controller 130 may generate the compensation data for the first light emitting line LN1 for each grayscale level. For grayscale levels between the measured grayscale levels, appropriate compensation data may be generated through linear interpolation.

This sensing step may be first performed before shipment of a product to generate the compensation data. Even after shipment, the timing controller 130 may update the compensation data stored in the memory by generating new compensation data through sensing during a time when the display is not operating. In a case where the compensation data is generated by sensing during a time when the display is not operating, the current value may be sensed by applying black data such that the light emitting element does not emit light.

Hereinafter, a process of inputting a pattern signal to a pixel circuit to cause the light emitting element to emit light and a process of sensing a current of the light emitting element will be described.

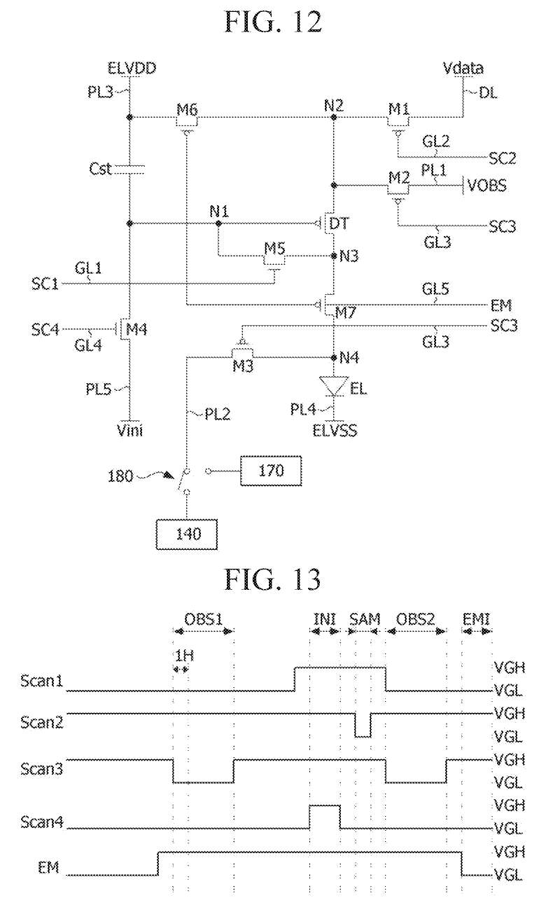

FIG. 12 is a circuit diagram of a pixel circuit according to one or more embodiments of the present disclosure.

Referring to FIG. 12, the pixel circuit includes the light emitting element EL, a driving element DT for driving the light emitting element EL, a plurality of switch elements M1, M2, M3, M4, M5, M6, and M7, and a capacitor Cst. The driving element DT and the switch elements M1, M2, M3, M4, M5, M6, and M7 may be implemented as transistors. Some of the switch elements M2, M3, M4, M5, M6, and M7 may constitute an internal compensation circuit that senses the threshold voltage of the driving element DT to compensate the data voltage.

The driving element DT includes a gate electrode connected to a first node n1, a first electrode connected to a second node n2, and a second electrode connected to a third node n3. The capacitor Cst is connected between the first node n1 and a node on a third power line PL3 to which a pixel driving voltage ELVDD is applied.

The light emitting element EL includes an anode electrode connected to a fourth node n4 and a cathode electrode connected to a fourth power line PL4 to which a cathode voltage ELVSS is applied.

A first switch element M1 is connected between a data line DL and the second node n2. The first switch element M1 is turned on in response to the gate low voltage VGL of a second scan signal SC2. When the first switch element M1 is turned on, the data line DL, to which a data voltage Vdata of the pixel data is applied, is connected to the second node n2. The first switch element M1 includes a gate electrode connected to a second gate line GL2 to which the second scan signal SC2 is applied, a first electrode connected to the data line DL, and a second electrode connected to the second node n2.

A second switch element M2 is connected between the second node n2 and a first power line PL1 to which a stress voltage VOBS is applied. The second switch element M2 is turned on in response to the gate low voltage VGL of a third scan signal SC3. When the second switch element M2 is turned on, the stress voltage VOBS is applied to the second node n2. The second switch element M2 includes a gate electrode connected to a third gate line GL3 to which the third scan signal SC3 is applied, a first electrode connected to the second node n2, and a second electrode connected to the first power line PL1.

A third switch element M3 is connected between the fourth node n4 and a second power line PL2 to which a reset voltage VAR is applied. The third switch element M3 is turned on in response to the gate low voltage VGL of the third scan signal SC3. When the third switch element M3 is turned on, the reset voltage VAR is applied to the anode electrode of the light emitting element EL connected to the fourth node n4. The third switch element M3 includes a gate electrode connected to the third gate line GL3, a first electrode connected to the fourth node n4, and a second electrode connected to the second power line PL2.

A fourth switch element M4 is connected between the first node n1 and a fifth power line PL5 to which an initialization voltage Vini is applied. The fourth switch element M4 is turned on in response to the gate high voltage VGH of a fourth scan signal SC4. When the fourth switch element M4 is turned on, the initialization voltage Vini is applied to the capacitor Cst and the gate electrode of the driving element DT connected to the first node n1. The fourth switch element M4 includes a gate electrode connected to a fourth gate line GL4 to which the fourth scan signal SC4 is applied, a first electrode connected to the first node n1, and a second electrode connected to the fifth power line PL5.

A fifth switch element M5 is connected between the first node n1 and the third node n3. The fifth switch element M5 is turned on in response to the gate high voltage VGH of a first scan signal SC1. When the fifth switch element M5 is turned on, the first node n1 is connected to the third node n3. Therefore, when the fifth switch element M5 is turned on, the driving element DT operates as a diode because its gate electrode and second electrode are connected. The fifth switch element M5 includes a gate electrode connected to a first gate line GL1 to which the first scan signal SC1 is applied, a first electrode connected to the first node n1, and a second electrode connected to the third node n3.

A sixth switch element M6 is connected between the third power line PL3, to which the pixel driving voltage ELVDD is applied, and the second node n2. The sixth switch element M6 is turned on in response to the gate low voltage VGL of the EM signal EM. When the sixth switch element M6 is turned on, the pixel driving voltage ELVDD is applied to the second node n2. The sixth switch element M6 includes a gate electrode connected to a fifth gate line GL5 to which the EM signal EM is applied, a first electrode connected to the third power line PL3, and a second electrode connected to the second node n2.

A seventh switch element M7 is connected between the third node n3 and the fourth node n4. The seventh switch element M7 is turned on in response to the gate low voltage VGL of the EM signal EM to connect the third node n3 to the fourth node n4. The seventh switch element M7 includes a gate electrode connected to the fifth gate line GL5, a first electrode connected to the third node n3, and a second electrode connected to the fourth node n4.

The pixel circuit may be connected to the first power line PL1 to which the stress voltage VOBS is applied, the second power line PL2 to which the reset voltage VAR is applied, the third power line PL3 to which the pixel driving voltage ELVDD is applied, the fourth power line PL4 to which the cathode voltage ELVSS is applied, and the fifth power line PL5 to which the initialization voltage Vini is applied. On the display panel, the power lines PL1 and PL3 to PL5 other than the second power line PL2 may be connected in common to all pixels 101. The second power line PL2 may not be connected in common to all pixels, but may be connected to the pixels arranged on a vertical line, allowing current to be sensed on a line-by-line basis.

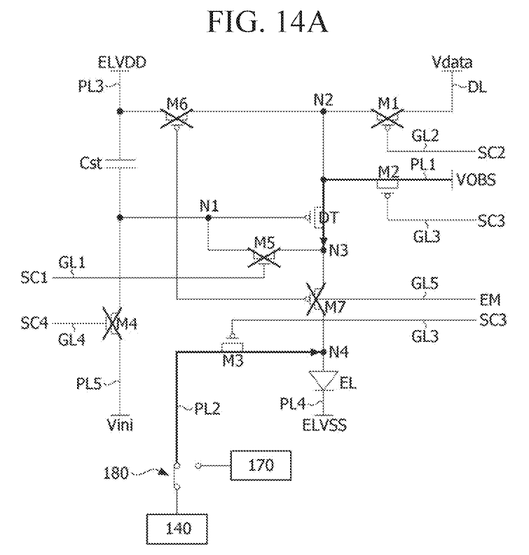

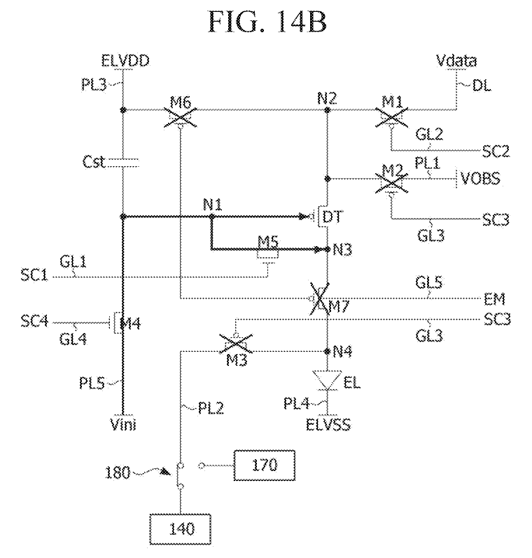

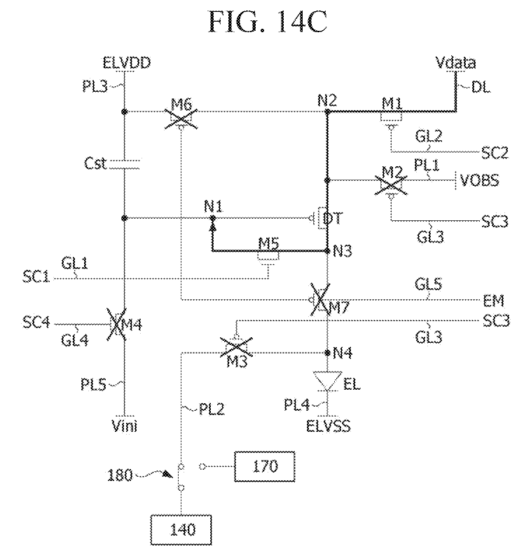

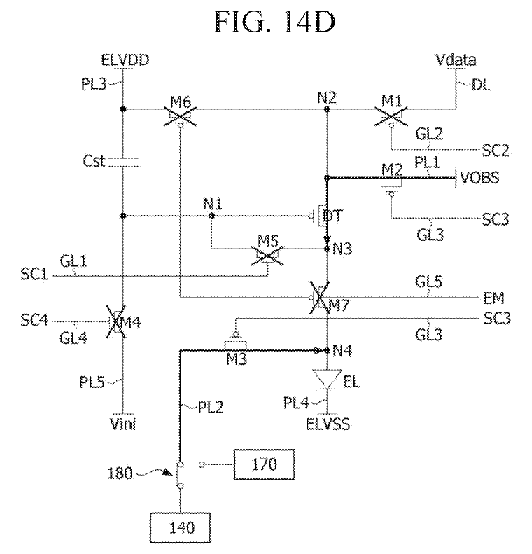

FIG. 13 is a waveform diagram illustrating a normal mode of the pixel circuit according to one or more embodiments of the present disclosure. FIGS. 14A to 14E are circuit diagrams showing the operation of the pixel circuit in sequential steps according to one or more embodiments of the present disclosure.

During a first on-bias period OBS1, the voltages of the first, third, and fourth scan signals SC1, SC3, and SC4 are the gate low voltage VGL, and the voltage of the second scan signal SC2 is the gate high voltage VGH. The voltage of the EM signal EM is the gate high voltage VGH during the first on-bias period OBS1. Therefore, during the first on-bias period OBS1, as shown in FIG. 14A, the second and third switch elements M2 and M3 are turned on, the stress voltage VOBS is applied to the second node n2, and the reset voltage VAR is applied to the fourth node n4.

Referring to FIG. 14A, during the first on-bias period OBS1, the first, fourth, fifth, sixth, and seventh switch elements M1, M4, M5, M6, and M7 are in the off state. During the first on-bias period OBS1, the driving element DT may be turned on, but a current cannot be supplied to the light emitting element EL because the seventh switch element M7 is in the off state. In addition, because a voltage difference between the reset voltage VAR and the cathode voltage ELVSS is smaller than the threshold voltage of the light emitting element EL, the light emitting element EL does not emit light during the first on-bias period OBS1.

Referring to FIG. 14B, during an initialization period INI, the voltages of the first to fourth scan signals SC1, SC2, SC3, and SC4 and the EM signal EM are the gate high voltage VGH. Therefore, during the initialization period INI, as shown in FIG. 14B, the fourth and fifth switch elements M4 and M5 are turned on, and the initialization voltage Vini is applied to the first and third nodes n1 and n3, and is also applied to the second node n2 through the driving element DT, which maintains the on state. During the initialization period INI, the light emitting element EL is in the off state and thus does not emit light.

During the initialization period INI, the voltages of the first, second, and third nodes n1, n2, and n3 are the initialization voltage Vini. During the initialization period INI, because the third and seventh switch elements M3 and M7 are in the off state, the fourth node n4 is floated and maintains its previous state.

Referring to FIG. 14C, during a sampling period SAM, the voltage of the second scan signal SC2 is generated as a scan pulse of the gate low voltage VGL synchronized with the data voltage Vdata of the pixel data, and is then inverted to the gate high voltage VGH. During the sampling period SAM, the voltages of the first and third scan signals SC1 and SC3 and the EM signal EM are the gate high voltage VGH, and the voltage of the fourth scan signal SC4 is the gate low voltage VGL. When the first switch element M1 is turned on during the sampling period SAM in response to the gate low voltage VGL of the scan pulse, the data voltage Vdata is applied to the second node n2, and the data voltage Vdata is also applied to the first and third nodes n1 and n3 through the driving element DT, which is in the on state. At this time, the voltage of the second node n2 is the data voltage Vdata, and the voltage of each of the first and third nodes n1 and n3 is Vdata+Vth, which is obtained by adding the threshold voltage Vth of the driving element DT to the data voltage Vdata. During the sampling period SAM, the fourth node n4 is in a floating state, and the light emitting element EL is in the off state and thus does not emit light.

Referring to FIG. 14D, during a second on-bias period OBS2, the voltages of the first, third, and fourth scan signals SC1, SC3, and SC4 are the gate low voltage VGL, and the voltage of the second scan signal SC2 is the gate high voltage VGH. The voltage of the EM signal EM is the gate high voltage VGH during the second on-bias period OBS2. During the second on-bias period OBS2, the first, fourth, fifth, sixth, and seventh switch elements M1, M4, M5, M6, and M7 are in the off state. Therefore, during the second on-bias period OBS2, as shown in FIG. 14D, the second and third switch elements M2 and M3 are turned on, the stress voltage VOBS is applied to the second node n2, and the reset voltage VAR is applied to the fourth node n4. During the second on-bias period OBS2, the light emitting element EL does not emit light.

Referring to FIG. 14E, during an emission period EMI, the voltages of the first and fourth scan signals SC1 and SC4 and the EM signal EM are the gate low voltage VGL, and the voltages of the second and third scan signals SC2 and SC3 are the gate high voltage VGH. During the emission period EMI, the sixth and seventh switch elements M6 and M7 are turned on in response to the gate low voltage VGL of the EM signal EM. Therefore, during the emission period EMI, a current path is formed between the pixel driving voltage ELVDD and the light emitting element EL.

During the emission period EMI, a current determined by the gate-source voltage of the driving element DT flows to the light emitting element EL, so that the light emitting element EL may emit light with a luminance corresponding to the grayscale value of the pixel data. During the emission period EMI, the first to fifth switch elements M1-M5 are in the off state.

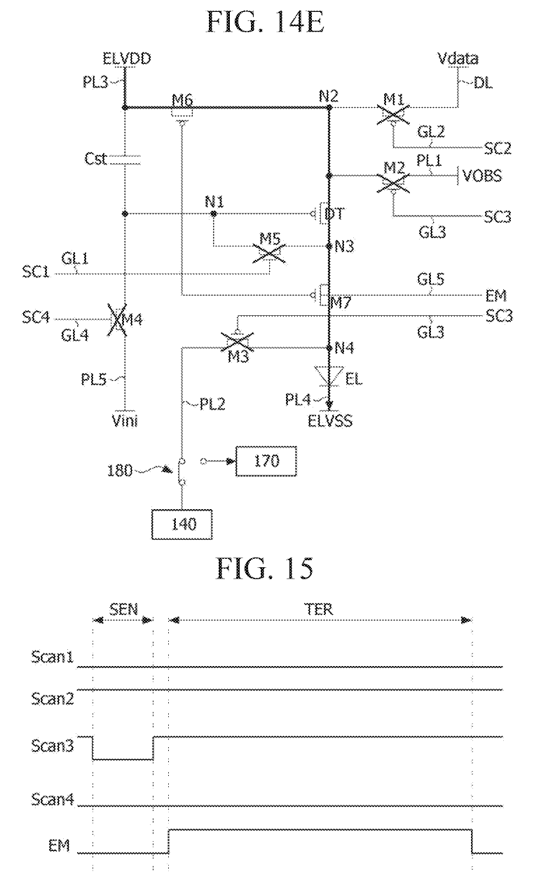

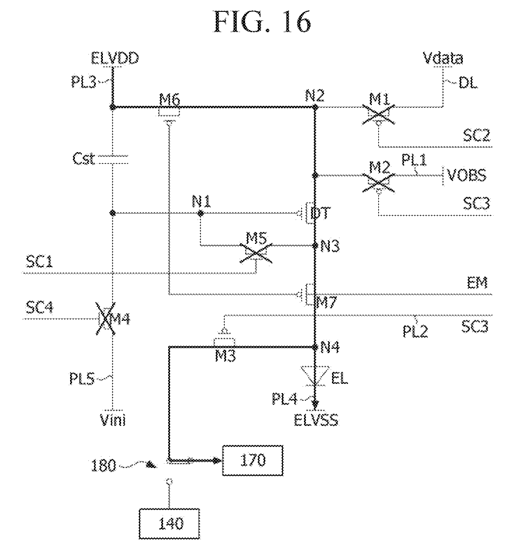

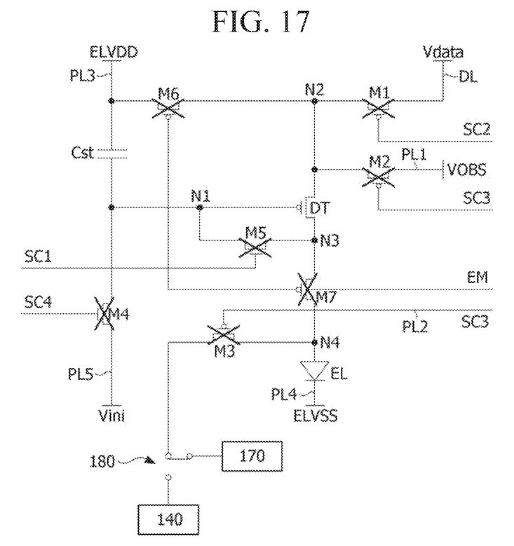

FIG. 15 is a waveform diagram illustrating a sensing mode of the pixel circuit according to one or more embodiments of the present disclosure. FIG. 16 is a circuit diagram illustrating an operation of the pixel circuit during a current sensing period according to one or more embodiments of the present disclosure. FIG. 17 is a circuit diagram illustrating an operation of the pixel circuit during an off period according to one or more embodiments of the present disclosure.

Referring to FIGS. 15 and 16, the sixth and seventh switch elements M6 and M7 are turned on in response to the gate low voltage VGL of the EM signal EM. Therefore, the state in which a current path is formed between the pixel driving voltage ELVDD and the light emitting element EL may be maintained during the emission period EMI. In this case, the second power line (the reset power line) PL2 may be connected to the sensing module 170 by the control switch module 180. Accordingly, the third switch element M3 may be turned on, and the sensing module 170 may sense the current flowing through the anode electrode of the light emitting element EL.

Referring to FIG. 17, in a floating period TER after the sensing period, the sixth and seventh switch elements M6 and M7 are turned off in response to the gate high voltage VGH of the EM signal EM, and the third switch element M3 is turned off in response to the gate high voltage VGH of the third scan signal SC3. Therefore, all switch elements are turned off, and no current flows.

The descriptions of the problem to be solved, the means to solve the problem, and the effect described above does not specify the essential features of the claims, and therefore the scope of the claims is not limited by what is described in the present disclosure.

Although the embodiments of the present disclosure have been described in more detail with reference to the accompanying drawings, the present disclosure is not necessarily limited to such embodiments, and may be variously modified within the scope thereof without departing from the technical spirit of the present disclosure. Therefore, the embodiments disclosed in the present disclosure are provided for illustrative purposes only and are not intended to limit the technical concept of the present disclosure, and the scope of the technical concept of the present disclosure is not limited thereto. Therefore, it should be understood that the embodiments described above are illustrative in all aspects and do not limit the present disclosure.

What is claimed is:

1. A display device, comprising:
a display panel including a plurality of pixels, each of the plurality of pixels having a light emitting element and a driving element;
a data driver configured to input a data voltage to the plurality of pixels;
a power supply module configured to input a reset voltage to an anode electrode of the light emitting element;
a sensing module configured to sense a current flowing through the anode electrode of the light emitting element;
a timing controller configured to control the data driver, the power supply module, and the sensing module; and
a control switch module configured to selectively connect a reset power line to the power supply module or the sensing module, the reset power line connected to the anode electrode of the light emitting element.

2. The display device of claim 1, wherein the timing controller controls the control switch module to connect the reset power line to the power supply module when sensing a threshold voltage of the driving element, and to connect the reset power line to the sensing module when the sensing module operates.

3. The display device of claim 1, wherein the sensing module converts the sensed current into a digital signal and transmits the digital signal to the timing controller,
wherein the timing controller generates compensation data using the digital signal and transmits image data to the data driver, and
wherein the compensation data is applied to the image data.

4. The display device of claim 1, wherein each of the plurality of pixels includes an internal compensation circuit configured to sense a threshold voltage of the driving element.

5. The display device of claim 1, wherein the driving element includes a gate electrode connected to a first node, a first electrode connected to a second node, and a second electrode connected to a third node, and
wherein the display device further comprising:
a first switch element connected between the second node and a data line, the first switch element configured to be turned on in response to a second scan signal;
a second switch element connected between the second node and a stress voltage, the second switch element configured to be turned on in response to a third scan signal; and
a third switch element connected between the anode electrode of the light emitting element and the reset voltage, the third switch element configured to be turned on in response to the third scan signal.

6. The display device of claim 5, further comprising:
a fourth switch element connected between the first node and an initialization voltage, the fourth switch element configured to be turned on in response to a fourth scan signal;
a fifth switch element connected between the first node and the third node, the fifth switch element configured to be turned on in response to a first scan signal;
a sixth switch element connected between the second node and a pixel driving voltage, the sixth switch element configured to be turned on in response to an emission control signal; and
a seventh switch element connected between the third node and the anode electrode, the seventh switch element configured to be turned on in response to the emission control signal.

7. The display device of claim 1, wherein when the display panel is in an off state, the sensing module senses a current flowing through the anode electrode of the light emitting element by connecting the sensing module to the reset power line while a voltage is applied to the light emitting element.

8. The display device of claim 1, wherein the plurality of pixels constitute a first light emitting line and a second light emitting line, and
wherein the control switch module includes:
a first control switch connected to a first reset power line that is connected in common to first pixels of the plurality of pixels of the first light emitting line; and
a second control switch connected to a second reset power line that is connected in common to second pixels of the plurality of pixels of the second light emitting line.

9. The display device of claim 8, wherein the first light emitting line is a line that does not satisfy a predetermined luminance range, and the second light emitting line is a line that satisfies the predetermined luminance range, and
wherein the timing controller includes a memory that stores position information of the first light emitting line and position information of the second light emitting line.

10. The display device of claim 8, wherein the timing controller senses the display panel on a block-by-block basis, and
wherein, for each block, the timing controller applies a voltage to the first light emitting line to sense a first current value of a plurality of light emitting elements of the plurality of pixels, applies a voltage to the second light emitting line to sense a second current value of the plurality of light emitting elements, and compares the first current value and the second current value to calculate compensation data.

11. A display device, comprising:
a display panel including a plurality of pixels, each of the plurality of pixels having a light emitting element and a driving element;
a data driver configured to apply a data signal to the plurality of pixels;
a gate driver configured to apply a scan signal to the plurality of pixels;
a power supply module configured to input a reset voltage through a reset power line connected to an anode electrode of the light emitting element;
a sensing module configured to sense a current flowing through the light emitting element by applying a voltage to a first light emitting line and a second light emitting line in which the plurality of pixels are connected; and
a timing controller configured to generate compensation data by comparing a first current value sensed from the first light emitting line with a second current value sensed from the second light emitting line,
wherein the sensing module applies a voltage to the first light emitting line to sense the first current value flowing through a plurality of light emitting elements of the plurality of pixels via a first reset power line connected to the first light emitting line, and
wherein the sensing module applies a voltage to the second light emitting line to sense the second current value flowing through the plurality of light emitting elements via a second reset power line connected to the second light emitting line.

12. The display device of claim 11, wherein the first light emitting line is a line that does not satisfy a predetermined luminance range, and the second light emitting line is a line that satisfies the predetermined luminance range, and
wherein the display device further comprising:
a memory that stores position information of the first light emitting line and position information of the second light emitting line.

13. The display device of claim 11, further comprising:
a control switch module including a first control switch connected to a first reset power line that is connected in common to first pixels of the plurality of pixels of the first light emitting line, and a second control switch connected to a second reset power line that is connected in common to second pixels of the plurality of pixels of the second light emitting line,
wherein the control switch module selectively connects the first reset power line and the second reset power line to the power supply module or the sensing module.

14. The display device of claim 13, wherein the timing controller controls the control switch module to connect the reset power line to the power supply module when sensing a threshold voltage of the driving element, and to connect the reset power line to the sensing module when the sensing module operates in a sensing mode.

15. The display device of claim 11, wherein the timing controller senses the display panel on a block-by-block basis, and
wherein, for each block, the timing controller applies a voltage to the first light emitting line to sense the first current value of the plurality of light emitting elements, applies a voltage to the second light emitting line to sense the second current value of the plurality of light emitting elements, and compares the first current value and the second current value to calculate the compensation data.
